(19) United States
(12) Patent Application Publication
(10) Pub. No.: US 2022/0411285 A1
(43) Pub. Date: Dec. 29, 2022

(54) CARTRIDGE FOR TREATING DRINKING WATER, AND METHOD FOR ENRICHING DRINKING WATER WITH SILICON

(71) Applicant: BWT Holding GmbH, Mondsee (AT)

(72) Inventors: Jürgen JOHANN, Nußloch (DE); Thomas SCHMIDT, Viernheim (DE)

(73) Assignee: BWT Holding GmbH, Mondsee (AT)

(21) Appl. No.: 17/780,051

(22) PCT Filed: Nov. 25, 2020
(86) PCT No.: PCT/EP2020/083310

§ 371 Date: Jul. 18, 2022

(30) Foreign Application Priority Data
Nov. 28, 2019 (DE) 10 2019 132 319.3
Feb. 26, 2020 (DE) 10 2020 104 962.5

(51) Int. Cl. C02F 1/00; C02F 1/28; C02F 1/42

(52) U.S. Cl. CPC C02F 1/003; C02F 1/281; C02F 1/283; C02F 1/42; C02F 2201/006; C02F 2303/08; C02F 2307/04

(57) ABSTRACT

A cartridge and a method for enriching drinking water with silicon are provided. A cross-linked silicic acid is used, which can be mixed with a cation exchanger that is preferably loaded with hydrogen and/or with alkalizing agents and/or with activated carbon. Silicon can be released into the water via the silicic acid.

### TECHNICAL FIELD

The disclosure relates to a cartridge for treating drinking water, which is used to enrich the drinking water with silicon and/or to soften it. More particularly, the disclosure relates to a cartridge for a table water filter, for an under-sink filter, or for a machine for preparing hot and/or cold beverages. The disclosure also relates to a method for treating drinking water.

### BACKGROUND

Drinking water usually contains only small amounts of silicon. Silicon is known to be an ultra-trace element which the human body needs and which is beneficial to health in many cases. A deficiency in silicon can cause health problems such as hair loss, brittle nails, impaired collagen formation, and reduced elasticity of the skin and blood vessels, as well as osteoporosis. Moreover, a range of diseases, such as diabetes, neurodermatitis, arteriosclerosis, kidney stones, and goiter is associated with silicon deficiency. With age, the levels of silicon can decrease in some tissues, such as blood vessels, bones and skin.

It is therefore important to provide the body with an adequate amount of silicon.

Moreover, it is possible to improve the taste of the water by adding silicon.

Preparations containing silicon have been known, for example in the form of silicic acid, also known as silica. Silicic acid can also be slurried in drinking water.

However, since silicic acid is only slightly soluble in water, the bioavailability with regard to silicon from silicic acid is only low. Accordingly, only a small percentage of the silicon in the ingested silica will get into the bloodstream.

Furthermore, it has been known from practice to add strongly alkaline sodium silicates to the water flow using a metering pump. However, such techniques are complex and not very suitable for producing small amounts of drinking water. Moreover, such additions increase the pH value of the water. Therefore, such techniques are primarily used for corrosion protection, in particular in industrial installations, since a protective layer will form on the pipes, in particular when using water glass.

### SUMMARY

The invention is based on the object of providing a cartridge and a method for treating drinking water, which allow to enrich the drinking water with silicon in a simple and efficient manner.

The object is achieved by a cartridge for treating drinking water and by a method for treating drinking water as disclosed herein. Preferred embodiments and refinements will be apparent from the subject-matter of the dependent claims, the description, and the drawings.

The disclosure relates to a cartridge for treating water.

The cartridge is in particular designed as a cartridge for a table water filter, a machine for preparing hot and/or cold beverages, and/or for an under-sink water filter.

The cartridge contains cross-linked silicic acid, in particular polysilicic acid.

The cross-linked silicic acid releases silicon when water is passed through.

Silicon will be referred to as SiO₂ below.

Preferably, a silica gel in the form of a water-containing porous, amorphous modification of silicon dioxide (SiO₂) is used as the cross-linked silicic acid.

Often, the terms of “amorphous silicon dioxide”, “polysilicic acid”, and “silicic acid dioxide” are used to refer to cross-linked silicic acid, cross-linked silica, and silica gel.

It has been found that, at least when choosing a material with a high moisture content and/or a high proportion of silanol groups, a sufficiently high solubility can be achieved to obtain sufficient silicon release.

The inventors assume that a hydrolysis reaction is necessary for the dissolution of cross-linked silicic acid. The rate of dissolution is thus dependent on the rate of hydrolysis, which in turn depends on the modification of the silicon dioxide. In the case of modifications of in particular strongly heated silicon dioxide with a framework structure that includes many Si—O—Si bonds, the energy requirement will be higher since this bond must first be cleaved. Therefore, modifications with a high water content and/or high loss on ignition are preferably used.

When the cross-linked silicic acid comes into contact with water, less polymerized or non-polymerized silicic acid (e.g. monosilicic acid, disilicic acid) will split off.

For example:

SiO₂₍ₛ₎+2H₂O [symbol] Si(OH)_{4(aq)}

Silicic acid is a weak acid. This means that the pH value and the conductivity of the treated water will change only insignificantly.

The cross-linked silicic acid used can be produced as described below, for example.

Possible starting materials for the cross-linked silicic acid include aqueous solutions of alkali metal silicate, preferably sodium silicate, from which an amorphous silicic acid is precipitated by adding an acid.

The precipitated silicic acid is filtered off, washed, and dried.

The silicic acid is preferably not heated to above 250° C. during drying, since otherwise the silanol groups might split off.

According to a preferred embodiment, the cross-linked silicic acid exhibits a loss on ignition at 1000° C. of 3% to 30%, preferably 5% to 25%, more preferably of 6% to 15%, yet more preferably of 7% to 10%, most preferably between 7% and 9% (similar to FGK-AV “Loss on Ignition” (2012-12)). Thus, the loss on ignition is determined in accordance with FGK-AV “Loss on Ignition”, but at a slightly lower temperature of 1000° C.

Loss on ignition is a measure of the proportion of silanol groups.

As mentioned above, silicic acids contain a certain proportion of chemically bound water in the form of silanol groups, which is determined through the loss on ignition at 1000° C. The loss on ignition can be determined on the basis of the initial substance, but is calculated on the basis of the substance dried at 105° C. or at 110° C. Thus, the loss on ignition relates to a sample that has been pre-dried at 105° C. or at 110° C.

Preferably, the silicic acid exhibits a loss on drying of more than 30%, preferably more than 40%, more preferably more than 50%, most preferably a loss on drying between 55 and 65%.

The loss on drying can be determined in compliance with DIN EN ISO 787-2-1995-04.

It has been found that the silicic acid can be heated to about 130° C. or even up to 145° C. and thereby dried without the solubility dropping significantly.

According to a preferred embodiment, the silicic acid has a specific surface area of more than 300 m²/g, preferably more than 700 m²/g, more preferably more than 800 m²/g, most preferably between 820 and 1000 m²/g.

The specific surface area can be determined according to the BET method in compliance with DIN ISO 9277-2017-07.

Preferably, silicic acid is used which has a solubility at 25° C. (in deionized water) of more than 80 mg/l, preferably more than 100 mg/l, and most preferably of more than 150 mg/l. In particular, the solubility thereof is between 140 and 180 mg/l (calculated as SiO₂).

The solubility can be determined by stirring a quantity of silicic acid which is sufficient so that it will not completely dissolve in warm water at 25° C. until saturation occurs.

The silicic acid and/or the cation exchanger can be in the form of granules, in particular with an average grain size between 0.5 and 3.0 mm.

The internal structure of silicic acid consists of a large network of interconnected microscopic pores with a high content of silanol groups which are capable of attracting and retaining water through physisorption and capillary effects. As a result, the material exhibits sufficient solubility in water.

This is achieved by using a silicic acid that has a high specific surface area and a high proportion of silanol groups (as distinguished by a high loss on ignition at 1000° C.).

The cartridge is preferably filled with synthetically produced silicic acid.

In particular substances registered under CAS nos. 112926-00-8, 7631-86-9, 1343-98-2, 7699-41-4, 63231-67-4, or 10193-36-9 can be used as the silicic acid. In addition to the silicon enrichment of drinking water, it has been found that corrosion protection can also be achieved in this way in a very effective manner.

Silicon precipitates and forms a protective layer on surfaces, in particular on the inner wall of metallic pipes.

In this way it is possible to reduce corrosion, in particular in the case of galvanized drinking water pipelines.

The water can also be used to fill heating or cooling circuits. This applies in particular to circuits comprising pipes made of unalloyed and low-alloyed ferrous materials.

The cartridge preferably contains 20 to 10,000 ml, preferably 80 to 200 ml of cross-linked silicic acid. The silicic acid is in particular in the form of granules.

The cartridge preferably contains both cross-linked silicic acid and an ion exchanger, in particular a cation exchanger.

The cation exchanger is preferably loaded with at least hydrogen, in particular to at least 10%, preferably at least 30% of its total capacity.

Furthermore, the cation exchanger can also be loaded with magnesium, in particular to at least 10% of its total capacity, for releasing magnesium into the drinking water.

Within the meaning of the disclosure, the information on the loading of ion exchange material is provided in particular on the basis of DIN 54403:2009-04 “Testing of ion exchangers—Determination of the total capacity of cation exchangers”.

It has been found that by using cross-linked silicic acid it is possible in a simple manner to release silicon into the water.

In combination with a cation exchanger it is possible to provide a filter cartridge which softens the drinking water and also adds silicon to the drinking water.

Cross-linked silicic acid and cation exchanger can be provided in a volume ratio from 1:10 to 10:1, preferably between 1:3 and 3:1.

In the context of the present disclosure, a weakly acidic ion exchange material is in particular understood to mean a material as specified in Hartinger, Ludwig, “Handbook of Waste Water and Recycling Technology for the Metal Processing Industry”, Carl Hanser Verlag, Munich, Vienna 1991, inter alia. According to chapter 5.2.3.3 of this handbook, a distinction is made for ion exchangers between cation exchangers and anion exchangers. Cation exchangers can be divided into strongly acidic and weakly acidic exchange resins, and anion exchangers can be divided into strongly basic and weakly basic exchange resins, which will behave as strong or weak acids or as strong or weak bases, respectively, in the exchange reactions.

The cation exchanger is preferably in the form of a weakly acidic ion exchanger, in particular a weakly acidic ion exchange resin.

Such an ion exchange material is commercially available under the trade name LEWATIT® 58229, for example,

As described above, the cation exchange material is preferably loaded with hydrogen, for softening the water.

According to a refinement, the cation exchanger is moreover loaded with other substances, in particular minerals such as magnesium, lithium, potassium, and/or zinc, preferably to at least 5%, more preferably to at least 20% of its total capacity.

Thus, further trace elements can be added to the drinking water, in addition to silicon.

The silicic acid and the cation exchanger are preferably provided as a mixed bed, in particular in the form of mixed granules.

In a further embodiment, the silicic acid and/or the cation exchanger can also be provided in the form of a powder or as a preferably porous block of interconnected particles.

If further trace elements are to be added via the cation exchanger, it is conceivable, on the one hand, to add a cation exchange material which is predominantly, in particular completely loaded with the further element(s).

On the other hand, it is also conceivable to load one and the same ion exchange material partly with hydrogen and partly with another type of ion, such as sodium, lithium, potassium, or zinc.

According to a refinement, the water is passed through an alkalizing filter material. In this refinement, the cartridge is moreover filled with an alkalizing filter material, in particular with at least one of the materials described below. The amount of alkalinizing filter material is preferably at least 5% by weight of the cross-linked silicic acid.

For this purpose, the cartridge may, for example, contain at least one or a mixture of at least two of the materials selected from the group consisting of dolomites, half-burnt dolomites, carbonates, in particular calcium carbonate and/or magnesium carbonate, oxides, in particular metal and/or semimetal oxides, in particular calcium oxide and/or magnesium oxide, and/or magnesium hydroxide, and/or alkali metal hydroxides and/or alkaline earth metal hydroxides.

The alkalizing filter material can be provided as a solid and in particular in the form of granules.

Preferably, the alkalizing filter material increases the pH of the water by at least 0.05, more preferably by at least 0.2 (compared to the pH of the water passed through the cross-linked silicic acid without the alkalizing filter material).

It has been found that the alkalizing filter material permits to increase the solubility of the cross-linked silicic acid, depending on the raw water. This leads to improved silicate formation.

Furthermore, increasing the pH value has a corrosion-reducing effect.

The simultaneous addition of silicate and alkalinization of the water results in a synergistic effect that enhances the protection against corrosion.

In addition, alkaline drinking water can also have a positive impact on human health, and some people also find alkaline drinking water tastes better.

The alkalizing material can in particular be employed in the form of a solid. For example, it can be in the form of granules, in particular with an average grain size of 0.5 to 3.0 mm.

The disclosure furthermore relates to a table water filter, a machine for preparing beverages, in particular hot and/or cold beverages, and to an under-sink water filter, which include the cartridge as described above.

The disclosure furthermore relates to a method for treating water, in particular by using a cartridge and/or a cross-linked silicic acid as described above.

The method is in particular performed using any one of the media as described above.

The method is in particular performed for producing a beverage, in particular a hot or cold beverage.

The water can also be used to fill a heating or cooling system.

The drinking water to be treated is passed through cross-linked silicic acid and is thereby enriched with silicon.

In terms of dwell time and amount of ion exchange material, the method is preferably adjusted such that 1 to 150 mg/l of silicon is added to the drinking water to be treated, preferably 10 to 70 mg/l silicon (silicon calculated as SiO₂ in each case).

Preferably, the drinking water to be treated is softened at the same time, in particular using any one of the cation exchange materials as described above.

With a dwell time of more than 10 s and/or less than 30 min, in particular less than 5 min, in particular between 20 s and 20 min, the cross-linked silicic acid described above allows to achieve an enrichment with silicon of more than 5 mg/l, preferably more than 10 mg/l, and more preferably of more than 20 mg/l (silicon calculated as SiO₂ in each case).

Hence, the enrichment mentioned above can be achieved with cartridges for table water filters, in which the dwell time of the water to be treated is less than one minute, as well as with large filters, for example for drinking water distribution networks, with dwell times of up to 30 minutes.

According to one embodiment, the water to be treated is passed through a reverse osmosis system prior to being passed through the cross-linked silicic acid.

This allows to achieve a predefined enrichment with silicon irrespectively of the salt content of the input water. That is, the water is first demineralized and then enriched with a defined amount of silicon.

It goes without saying that, in addition to silicon, other minerals can be added to the water as well, in particular magnesium.

### BRIEF DESCRIPTION OF THE DRAWINGS

The subject-matter of the disclosure will now be explained in more detail by way of schematically illustrated exemplary embodiments with reference to the drawings of FIGS. 1 through 5.

FIG. 1 is a perspective view of a table water filter.

FIG. 2 is a cut-away view of a cartridge containing an ion exchange material.

FIG. 3 shows a filter candle.

FIG. 4 schematically shows the cartridge installed in the tank of a beverage preparation machine.

FIG. 5 is a graph showing the Si enrichment of drinking water over the service life of a filter cartridge.

### DETAILED DESCRIPTION

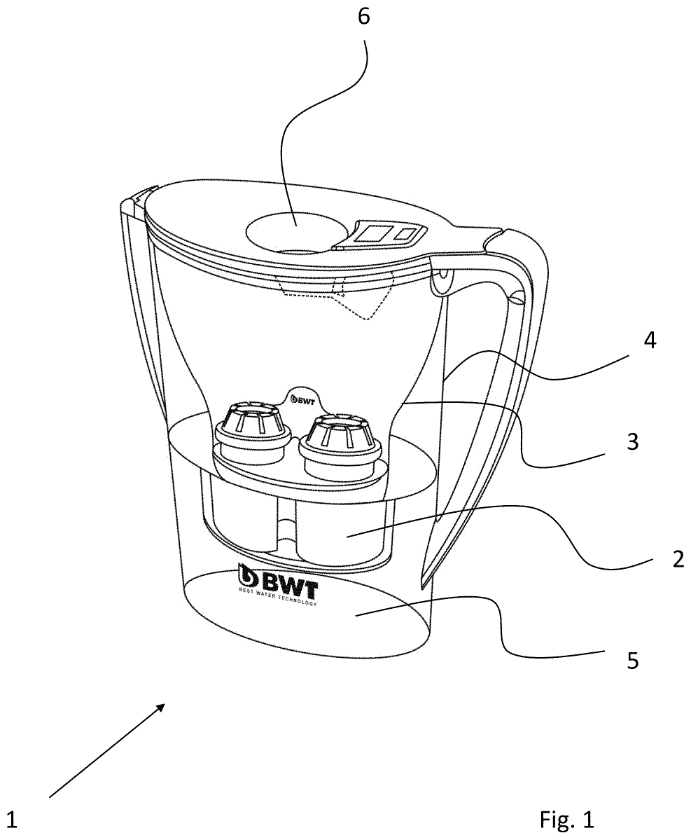

FIG. 1 shows a perspective view of a table water filter 1.

It is in the form of a gravity-driven water treatment device which is used in particular in the household.

Table water filter 1 comprises a filter cartridge 2 which is disposed in a funnel 3 which in turn is placed in the jug 4.

Drinking water can be filled into the funnel 3 via filling opening 6 and will then pass through the cartridge 2 and accumulate in the water collection space 5.

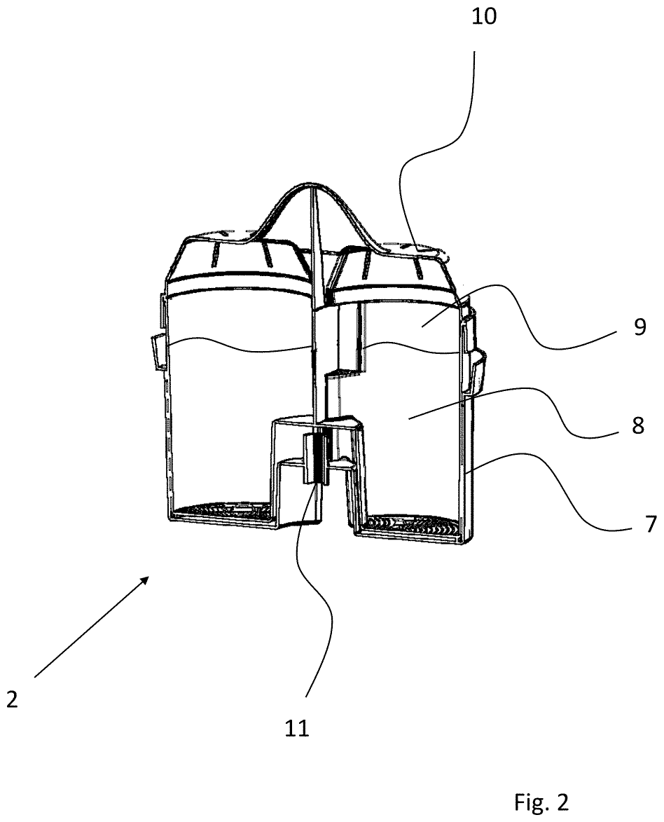

FIG. 2 shows a cut-away view of the cartridge 2 illustrated in FIG. 1.

Cartridge 2 comprises a housing 7 which has at least one chamber 9 that is filled with an ion exchange material and cross-linked silicic acid 8.

The filling material of the cartridge 2 is in particular in the form of granules, provided in the form of a mixed bed with a weakly acidic ion exchanger loaded with hydrogen ions and cross-linked silicic acid and optionally an alkalizing filter material.

Chamber 9 may also be filled with further water treatment media, in particular with activated carbon (not shown).

During operation, water runs into the chamber 9 via inlet openings 10, passes through the filling material 8 and leaves the cartridge 2 via outlet 11.

It goes without saying that filters or meshes for removing suspended matter and/or for retaining filling material 8 (not illustrated) can furthermore be provided upstream or downstream the filling material 8.

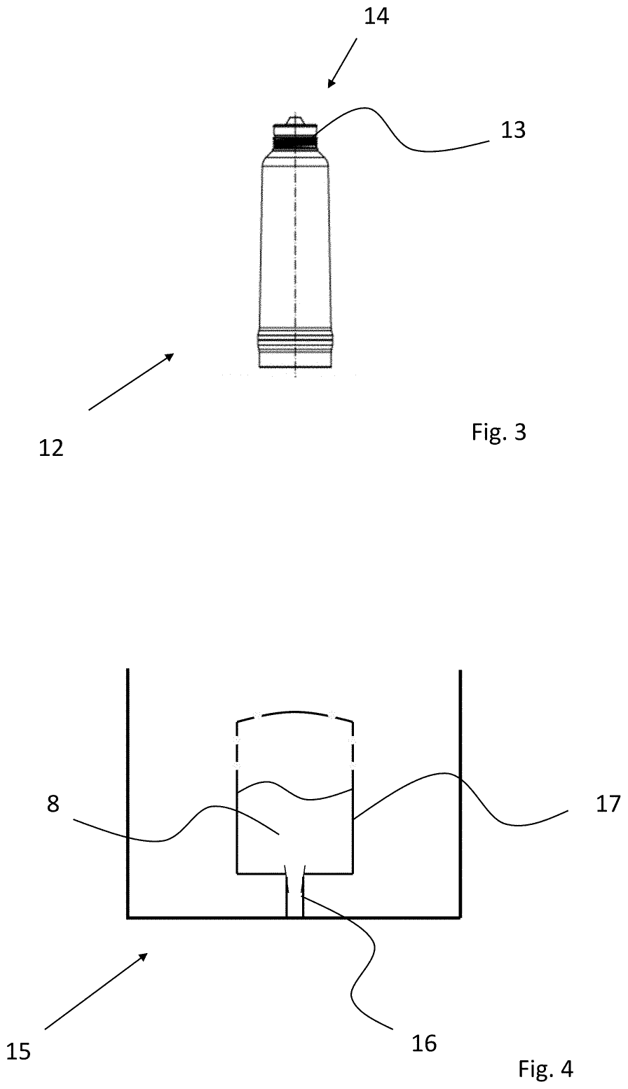

FIG. 3 shows an alternative embodiment of a device for treating water, which is in the form of a filter candle 12.

In contrast to the cartridge described above, such a filter candle 12 is flowed through not due to gravity, but rather is connected to a drinking water pipe via a suitable adapter.

For this purpose, the filter candle has a head 14 with a thread 13.

The head 14 comprises the inlet and the outlet. Filter cartridge 12 can be easily screwed in via the thread 13. The basic structure of such filter candles is known to those skilled in the art.

FIG. 4 schematically shows the tank 15 of a machine for preparing beverages, in particular a machine for preparing coffee.

Tank 15 has an intake port 16, through which water is supplied to the machine by a pump.

A filter cartridge 17 is plugged to the intake port 16, which filter cartridge is filled with an ion exchange material and cross-linked silicic acid 8. The ion exchange material is loaded with hydrogen, in accordance with the embodiments described above.

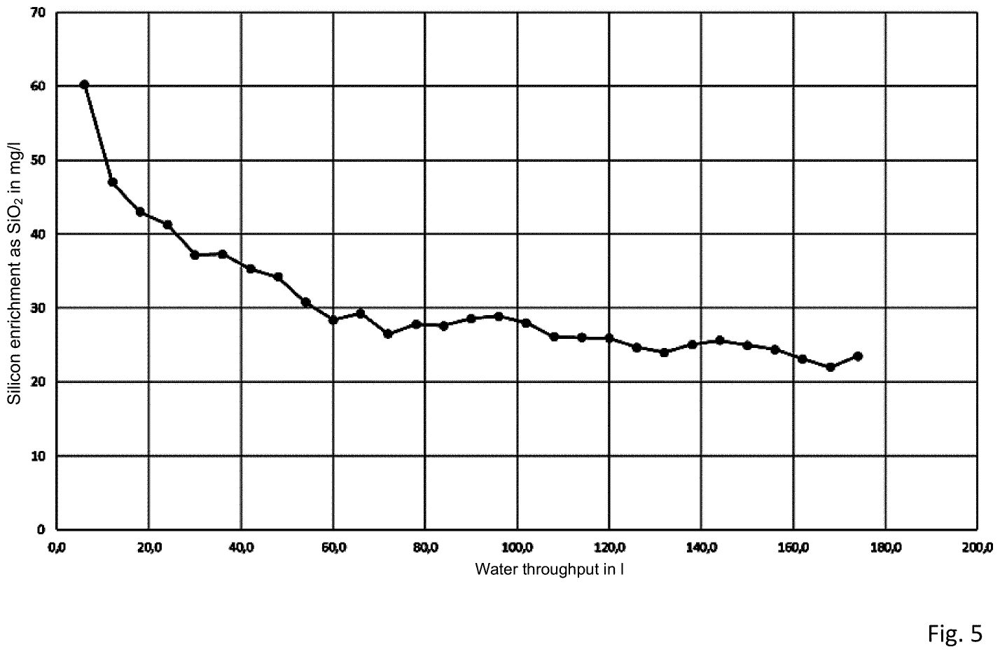

The enrichment of the drinking water with silicon will now be explained in more detail with reference to the graph of FIG. 5.

For this series of measurements, 120 ml of cross-linked silicic acid was filled into a cartridge. The filter bed was then rinsed with deionized water and used for a series of measurements for which silicon-free water with a total hardness of 26° dH and a carbonate hardness of 17° dH was used. The silicon content was determined in the eluate.

In the graph, the amount of filtered water is plotted on the x-axis, and the silicon content of the eluate is plotted on the y-axis.

It can be seen that silicon dissolves in a sufficient concentration and a plateau forms at 20 to 30 mg/l SiO₂.

When admixed to a weakly acidic cation exchange material, the granules illustrated herein can be used to enrich the water with silicon and at the same time to soften it over the entire service life of the filter cartridge.

### LIST OF REFERENCE NUMERALS

1 Table water filter
2 Cartridge
3 Funnel
4 Jug
5 Water collection space
6 Filling opening
7 Housing
8 Filling material (mixture of ion exchange material and silicon dioxide)
9 Chamber
10 Inlet opening
11 Outlet
12 Filter candle
13 Thread
14 Head
15 Tank
16 Intake port
17 Filter cartridge

1.-18. (canceled)

19. A cartridge for treating water, comprising cross-linked silicic acid which, when water is passed therethrough, releases an amount of silicon such that for a dwell time of between 20 s and 20 min, an enrichment of the water with silicon of more than 5 mg/l, is achieved.

20. The cartridge as claimed in claim 19, wherein the cartridge contains activated carbon.

21. The cartridge as claimed in claim 19, wherein the cartridge contains a cation exchanger.

22. The cartridge as claimed in claim 19,
wherein the cartridge contains an alkalizing filter material which comprises at least one of the materials selected from the group consisting of dolomites, half-burnt dolomites, calcium carbonate, magnesium carbonate, metal oxides, semimetal oxides, calcium oxide, magnesium oxide, magnesium hydroxide, alkali metal hydroxides, and alkaline earth metal hydroxides.

23. The cartridge as claimed in claim 19, wherein the cartridge is adapted for a pressure-driven or gravity-driven filter system.

24. The cartridge as claimed in claim 23, wherein the cross-linked silicic acid exhibits a loss on ignition at 1000° C. between 7% and 9%.

25. The cartridge as claimed in claim 19, wherein the cross-linked silicic acid exhibits a loss on drying between 55 and 65%.

26. The cartridge as claimed in claim 19, wherein the cross-linked silicic acid has a specific surface area between 820 and 1000 m²/g.

27. The cartridge as claimed in claim 19, wherein the cross-linked silicic acid exhibits a solubility at 25° C. of more than 80 mg/l.

28. The cartridge as claimed in claim 21, wherein the cross-linked silicic acid and/or the cation exchanger are in the form of granules with an average grain size from 0.5 to 3.0 mm.

29. The cartridge as claimed in claim 28,
wherein the cation exchanger is loaded with at least hydrogen to at least 30% of its total capacity; and/or
wherein it is filled with cross-linked silicic acid which has an SiO₂ content, calculated on a basis of the dried substance, of at least 50%; or
wherein the cross-linked silicic acid and the cation exchanger are provided in a volume ratio of 1:3 to 3:1; and/or
wherein the cation exchanger is in the form of a weakly acidic cation exchange resin.

30. The cartridge as claimed in claim 21,
wherein the cation exchanger is loaded with magnesium, sodium, lithium, zinc, and/or potassium to at least 5% of its total capacity; or
wherein the cartridge is in the form of a disposable cartridge for a table water filter, an under-sink water filter, or for a machine for preparing beverages; or
wherein the cartridges contain 20 ml to 10000 l of medium.

31. A table water filter, machine for preparing beverages, or under-sink water filter, comprising the cartridge according to claim 19.

32. A method for treating water, comprising:
providing the cartridge as in claim 19;
passing water to be treated through the cross-linked silicic acid and thereby enriching the water with silicon,
wherein with a dwell time of between 20 s and 20 min, an enrichment with silicon of more than 5 mg/l is achieved.

33. The method as claimed in claim 32, wherein the water to be treated is enriched with 1 to 150 mg/l of silicon.

34. The method as claimed in claim 32, wherein the water to be treated is passed through a reverse osmosis system prior to being passed through the cross-linked silicic acid.

35. The method as claimed in claim 32, wherein the water to be treated is softened using a cation exchanger.

36. The method as claimed in claim 32, further comprising:
filling a heating or cooling system with the treated water.
